(19) United States
(12) Patent Application Publication
(10) Pub. No.: US 2023/0182615 A1
(43) Pub. Date: Jun. 15, 2023

(54) ENERGY AGGREGATION SYSTEM

(71) Applicant: eCamion Inc., Toronto (CA)

(72) Inventors: Carmine N. Pizzurro, Toronto (CA); Himanshu Sudan, Toronto (CA); Richard W. Szymczyk, Toronto (CA); Youhan Fu, Toronto (CA); Reza Iravani, Toronto (CA)

(21) Appl. No.: 17/551,301

(22) Filed: Dec. 15, 2021

(51) Int. Cl. B60L 55/00; B60L 53/18; B60L 53/62; B60L 53/63; B60L 53/51; B60L 53/52

(52) U.S. Cl. CPC B60L 55/00; B60L 53/18; B60L 53/62; B60L 53/63; B60L 53/51; B60L 53/52; B60L 2210/40; B60L 2210/30; B60L 2210/10

(57) ABSTRACT

An energy aggregation system comprises a bus configured to receive power from one or more power sources and to deliver power to a grid connected to the bus; at least one energy storage system connected to the bus and configured either to draw power from the bus or discharge power to the bus; at least one electric vehicle charging stall connected to the bus and configured to deliver power, from an electric vehicle load connected to the at least one electric vehicle charging stall, to the bus; and at least one control module configured to monitor power on the bus and control delivery of power from the bus to the grid.

### FIELD

The subject disclosure relates to an energy aggregation system.

### BACKGROUND

Climate change has become an increasingly more popular topic and with it, a push has been made on many fronts to reduce reliance on fossil fuels and move to sources of cleaner “green” energy. Not surprisingly, in view of this push the introduction of electric vehicles has been embraced by both individual consumers and industry.

Since 2018, transportation electrification has become more and more a point of attention in both developed and developing countries. This is especially true in countries acknowledging climate change and reinforcing requirements on emission reduction and advancements of electric vehicle technologies. In such countries, the electric bus has become one of the most popular vehicles, due to its low requirement on public transit infrastructure change and high similarity to the conventional busses that run on fossil fuels. In addition to running on cleaner power, electric busses have the benefit that they may help to reduce operating costs through, for example, automated charging instead of manual refueling, and improve resource efficiency by allowing existing public transit infrastructure to be used for grid servicing.

Although the introduction of electric busses to public transit systems continues and advantages are expected, challenges are also expected. The mass introduction of high power electric bus supply equipment (EBSE) at approximately 350 W to 500 kW, may affect the performance of existing power distribution infrastructure, and the ability to integrate existing public transit infrastructure or renewable power sources into electric bus charging networks.

Furthermore in public transit systems with mass deployment of electric busses, the connectivity, control and coordination within and between electric bus charging depots, where available charging stalls or slots and available charging power must be constantly monitored to allow charging sessions to be scheduled, presents challenges.

The deployment of electric vehicle charging depots however, also provides opportunities for power delivery to utility grids when vehicle-to-grid (V2G) capabilities are employed. That said, using electric vehicle loads as a source of power to deliver power to utility grids presents challenges as electric vehicle loads can be inconsistent. For example, electric vehicle loads may disconnect either intentionally or due to tripping as a result of a fault before grid power delivery has been completed, may not have sufficient charge to complete grid power delivery, or may have curtailed power output at low states of charge. Also, the number and/or sizes of electric vehicle loads that are available at any given time may be insufficient to satisfy grid power delivery. As will be appreciated, in environments of this nature, improvements are desired.

It is therefore an object to provide a novel energy aggregation system.

This background serves only to set a scene to allow a person skilled in the art to better appreciate the following detailed description. None of the above discussion should necessarily be taken as an acknowledgment that this discussion is part of the state of the art or is common general knowledge.

### BRIEF DESCRIPTION

It should be appreciated that this brief description is provided to introduce a selection of concepts in a simplified form that are further described below in the detailed description. This brief description is not intended to be used to limit the scope of claimed subject matter.

Accordingly, in one aspect there is provided an energy aggregation system comprising: a bus configured to receive power from one or more power sources and to deliver power to a grid connected to the bus; at least one energy storage system connected to the bus and configured either to draw power from the bus or discharge power to the bus; at least one electric vehicle charging stall connected to the bus and configured to deliver power, from an electric vehicle load connected to the at least one electric vehicle charging stall, to the bus; and at least one control module configured to monitor power on the bus and control delivery of power from the bus to the grid.

In one or more embodiments, the energy aggregation system comprises a plurality of electric vehicle charging stalls, each electric vehicle charging stall configured to deliver power, from an electric vehicle load connected to the electric vehicle charging stall, to the bus.

In one or more embodiments, the energy aggregation system comprises at least one renewable energy source configured to deliver power to the bus. In one form, the at least one renewable energy source comprises at least one solar power and/or wind power source.

In one or more embodiments, the at least one control module is configured to control delivery of power from the bus to the grid according to a setpoint. In one form, the setpoint is determined by an operator of the grid.

In one or more embodiments, the at least one control module is configured to condition operation of the at least one energy storage system either to draw power from the bus or discharge power to the bus in order to balance power on the bus. In one form, the at least one control module is configured to (i) condition the at least one energy storage system to draw power from the bus when excess power is on the bus and the state of charge of the at least one energy storage system is below an upper state of charge level, and (ii) condition the at least one energy storage system to discharge power to the bus when insufficient power is on the bus and the state of charge of the at least one energy storage system is above a lower state of charge level. In one form, power on the bus is balanced according to the equation:

P_ESS=P_2grid_ref−P_renewable−ΣP_EV_Loads

where:
P_ESS is the power drawn from or discharged to the bus by the at least one energy storage system;
P_2grid_ref is the setpoint;
P_renewable is the power delivered to the bus by the at least one renewable power source; and
ΣP_EV_Loads is the total power delivered to the bus by electric vehicle loads connected to the electric vehicle charging stalls.

In one or more embodiments, the bus is a direct current (DC) bus. In one form, the at least one renewable energy source, the at least one energy storage system and the electric vehicle charging stalls deliver DC power to the DC bus. In one form, at least one of each renewable energy source, and each energy storage system is connected to the DC bus via a DC to DC converter. In one form, each electric vehicle charging stall comprises a DC to DC converter module and an electric vehicle charging interface. Each DC to DC converter module may comprise a DC to AC converter, a high frequency step down transformer, and an AC to DC converter connected in series.

In one or more embodiments, the grid is an alternating current (AC), three phase utility grid and the energy aggregation system further comprises power conditioning circuitry to filter and convert DC power on the bus to AC power for delivery to the grid.

In one or more embodiments, the bus is an alternating current (AC) bus. The at least one renewable energy source, the at least one energy storage system and the electric vehicle charging stalls deliver AC power to the AC bus. In one form, each renewable energy source, and each energy storage system is connected to the AC bus via a DC to AC converter. In one form, each electric vehicle charging stall comprises a DC to AC converter module and an electric vehicle charging interface.

In one or more embodiments, the at least one energy storage system is at least one battery energy storage system comprising a plurality of rechargeable batteries.

### BRIEF DESCRIPTION OF THE DRAWINGS

Embodiments will now be described more fully with reference to the accompany drawings in which:

FIG. 1 is a schematic diagram of an energy aggregation system with vehicle-to-grid (V2G) capability; and

FIG. 2 is a schematic diagram of an alternative energy aggregation system with vehicle-to-grid (V2G) capability.

### DETAILED DESCRIPTION

The foregoing brief description, as well as the following detailed description of certain examples will be better understood when read in conjunction with the accompanying drawings. As used herein, a feature, structure, element, component etc. introduced in the singular and preceded by the word “a” or “an” should be understood as not necessarily excluding the plural of the features, structures, elements, components etc. Further, references to “one example” or “one embodiment” are not intended to be interpreted as excluding the existence of additional examples or embodiments that also incorporate the described features, structures, elements, components etc.

Unless explicitly stated to the contrary, examples or embodiments “comprising” or “having” or “including” a feature, structure, element, component etc. or a plurality of features, structures, elements, components etc. having a particular property may include additional features, structures, elements, components etc. not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed features, structures, elements, components or other subject matter.

It will be understood that when a feature, structure, element, component etc. is referred to as being “on”, “attached” to, “affixed” to, “connected” to, “coupled” with, “contacting”, etc. another feature, structure, element, component etc. that feature, structure, element, component etc. can be directly on, attached to, connected to, coupled with or contacting the feature, structure, element, component etc. or intervening features, structures, elements, components etc. may also be present. In contrast, when a feature, structure, element, component etc. is referred to as being, for example, “directly on”, “directly attached” to, “directly affixed” to, “directly connected” to, “directly coupled” with or “directly contacting” another feature, structure, element, component etc. there are no intervening features, structures, elements, components etc. present.

It will be understood that spatially relative terms, such as “under”, “below”, “lower”, “over”, “above”, “upper”, “front”, “back” and the like, may be used herein for ease of description to describe the relationship of a feature, structure, element, component etc. to another feature, structure, element, component etc. as illustrated in the figures. The spatially relative terms can however, encompass different orientations in use or operation in addition to the orientation depicted in the figures.

Reference herein to “example” means that one or more feature, structure, element, component, characteristic and/or operational step described in connection with the example is included in at least one embodiment and/or implementation of the subject matter according to the subject disclosure. Thus, the phrases “an example,” “another example,” and similar language throughout the subject disclosure may, but do not necessarily, refer to the same example. Further, the subject matter characterizing any one example may, but does not necessarily, include the subject matter characterizing any other example.

Reference herein to “configured” denotes an actual state of configuration that fundamentally ties the feature, structure, element, component, or other subject matter to the physical characteristics of the feature, structure, element, component or other subject matter preceding the phrase “configured to”. Thus, “configured” means that the feature, structure, element, component or other subject matter is designed and/or intended to perform a given function. Thus, the use of the term “configured” should not be construed to mean that a given feature, structure, element, component, or other subject matter is simply “capable of” performing a given function but that the feature, structure, element, component, and/or other subject matter is specifically selected, created, implemented, utilized, and/or designed for the purpose of performing the function. Subject matter that is described as being configured to perform a particular function may additionally or alternatively be described as being operative to perform that function.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately”, “about”, “substantially”, “generally” etc. represent an amount or condition close to the stated amount or condition that results in the desired function being performed or the desired result being achieved. For example, the terms “approximately”, “about”, “substantially”, “generally” etc. may refer to an amount or condition that is within engineering tolerances to the precise value or condition specified that would be readily appreciated by a person skilled in the art.

In general, an energy aggregation system is described that comprises a bus configured to receive power from one or more power sources and to deliver power to a grid connected to the bus. At least one energy storage system is connected to the bus and configured either to draw power from the bus or discharge power to the bus. At least one electric vehicle charging stall is connected to the bus and is configured to deliver power, from an electric vehicle load connected to the at least one electric vehicle charging stall, to the bus. At least one control module is configured to monitor power on the bus and control delivery of power from the bus to the grid. Further specifics concerning exemplary energy aggregation systems will now be described.

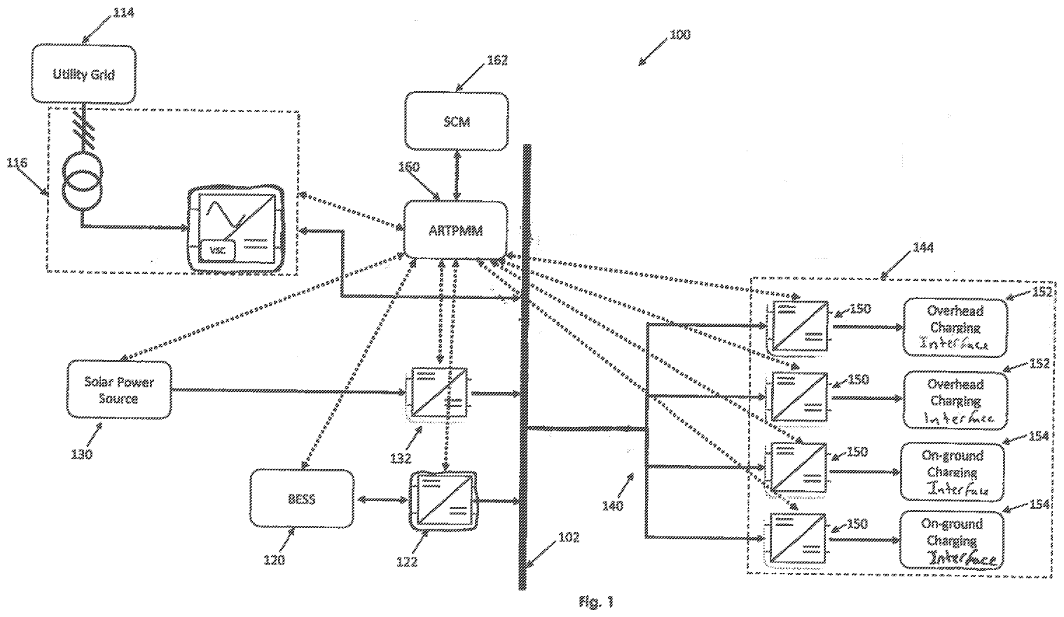

Turning now to FIG. 1, a schematic diagram of an energy aggregation system with vehicle-to-grid (V2G) capability is shown and is generally identified by reference numeral 100. In this embodiment, the energy aggregation system 100 comprises a common direct current (DC) bus or node 102 that receives power from one or more sources of power. In a charging mode, the energy aggregation system 100 provides power from the common DC bus 102 to electric vehicle charging equipment in electric vehicle charging stalls of one or more electric vehicle charging bays to allow electric vehicles to be charged. In a recovery mode, the energy aggregation system 100 provides power from the common DC bus 102 to a utility grid.

In the embodiment shown, the common DC bus 102 is connected to three (3) separate sources of power. Those of skill in the art will appreciate however that the common DC bus 102 may receive power from more or fewer sources of power. In this example, the common DC bus 102 is connected to a three-phase alternating current (AC) utility grid 114 via a feeder station 116. The feeder station 116 comprises, for example, circuit breakers and contactors, a static VAR compensator, a transformer, and power conditioning circuitry comprising a three-phase, bi-directional voltage source converter (VSC). As is known to those of skill in the art, the circuit breakers open automatically during unsafe conditions to electrically isolate the feeder station 116 from the utility grid 114. The contactors can be controlled manually or automatically to isolate the feeder station 116 from the utility grid 114. The static VAR compensator is configured to filter harmonics, regulate the output voltage, and control the power factor to keep the power factor close to unity. During power delivery from the utility grid 114 to the common DC bus 102, the transformer steps down the AC voltage received from the utility grid 114 to the required voltage (e.g. 600V) and the bi-directional VSC converts the AC power to DC power for supply to the common DC bus 102. During power delivery from the common DC bus 102 to the utility grid 114, the bi-directional VSC converts DC power received from the common DC bus 102 to AC power. The VAR compensator filters the AC power and the transformer steps up the AC voltage to the required voltage for supply to the utility grid 114 or to designated loads at a host facility (not shown).

The common DC bus 102 is connected to one or more energy storage systems 120 via one or more bi-directional DC to DC converters 122, only one energy storage system 120 and bi-directional DC to DC converter of which are shown for ease of illustration. In this example, the energy storage system 120 is a battery energy storage system (BESS). BESS 120 comprises a bank of rechargeable energy storage devices in the form of rechargeable batteries and is configured to deliver DC power to the common DC bus 102 via the bi-directional DC to DC converter 122 when insufficient DC power levels on the common DC bus 102 are detected thereby to stabilize power on the common DC bus 102. BESS 120 is also configured to draw DC power from the common DC bus 102 via the bi-directional DC to DC converter 122 when excess DC power is on the common DC bus 102 allowing the BESS 120 to charge.

Depending on the geographical location of the energy aggregation system 100, the common DC bus 102 may also be connected to one or more other sources of power such as renewable power sources e.g. solar power farms, wind power farms etc. For example as shown in FIG. 1, the common DC bus 102 is connected to and receives power from a solar power source 130 comprising one or more solar panel arrays via a DC to DC converter 132. The DC to DC converter 132 is configured to ensure the DC output of the solar power source 130 is at the required voltage for supply to the common DC bus 102.

The common DC bus 102 is also connected to one or more electric vehicle charging bays 140, one electric vehicle charging bay of which is shown for illustrative purposes only. The electric vehicle charging bay 140 comprises a plurality of electric vehicle charging stalls 144 configured to facilitate both the charging of electric cars and/or trucks and the charging of electric busses. In the example shown, the electric vehicle charging bay 140 comprises four (4) electric vehicle charging stalls 144. Two of the electric vehicle charging stalls 144 are particularly suited to facilitate charging of electric busses and two of the electric vehicle charging stalls 144 are particularly suited to facilitate charging of electric cars and/or trucks. In the case of the electric vehicle charging stalls 144 configured to facilitate charging of electric busses, each electric vehicle charging stall 144 comprises a DC to DC converter module 150 and an overhead charging interface 152 configured to engage with the pantograph on the top of an electric bus. In the case of the electric vehicle charging stalls 144 configured to facilitate charging of electric cars and/or trucks, each electric vehicle charging stall 144 comprises a DC to DC converter module 150 and an on-ground charging interface 154 having a power cable and connector (not shown) to engage with an electric car or truck.

Each DC to DC converter module 150 comprises a DC to AC converter, an intermediate high frequency step down transformer, and an AC to DC converter that are connected in series. Each DC to DC converter module 150 is connected between common DC bus 102 and its associated charging interface 152, 154 and is configured to provide up to about 125 kW within a voltage range of about 200V to about 500V to electric vehicle loads via the associated charging interface 152, 154.

Although the electric vehicle charging bay 140 is shown as having four electric vehicle charging stalls 144, those of skill in the art will appreciate that this is for ease of illustration only. In a typical energy aggregation system 100, the electric vehicle charging bay 140 will include more electric vehicle charging stalls 144 with the number and configuration of the electric vehicle charging stalls 144 being selected to allow the fleet of vehicles that use the energy aggregation system 100 to be properly serviced. Of course if desired, the electric vehicle charging bay 140 may have fewer electric vehicle charging stalls 144.

In this embodiment, the energy aggregation system 100 employs two levels of management and control that govern the real-time performance of the energy aggregation system 100, the scheduling of electric vehicle charging sessions in a charging mode, and the scheduling of power delivery to the utility grid 114 in a recovery mode. In particular, the energy aggregation system 100 comprises an adaptive real-time power management module (ARTPMM) 160 configured to monitor, analyze, and control power flow to and from the common DC bus 102 and a supervisory control module (SCM) 162 configured to manage total energy usage, energy allocation, electric vehicle charging scheduling, grid services and the connectivity/interfacing with external systems.

The ARTPMM 160 in this embodiment is configured to (i) measure external load and power quality on the common DC bus 102, (ii) estimate and control incoming power received from each renewable power source such as the solar power source 130, and (iii) plan and assign a setpoint with respect to power draw from the utility grid 114. Based on (i), (ii), and (iii), the ARTPMM 160 in the charging mode is configured to (iv) plan and set the maximum power draw limit of each electric vehicle charging stall 144 from the common DC bus 102. Based on (i), (ii), (iii), and (iv), the ARTPMM 160 in the charging mode is configured to (v) plan and adjust power draw from the BESS 120 to the common DC bus 102 via the bi-directional DC to DC converter 122 or power supply to the BESS 120 from the common DC bus 102 via the bi-directional DC to DC converter 122.

The ARTPMM 160 communicates with the feeder station 116, the bi-directional DC to DC converter 122, the solar power source 130, the DC to DC converter 132, and the DC to DC converter modules 150 as indicated by the dotted lines shown in FIG. 1. The ARTPMM 160 in this embodiment resides on a programmed computing device such as a host computer, server or other suitable processing device that comprises, for example, one or more processors, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the one or more processors.

The SCM 162 in this embodiment similarly resides on a programmed computing device such as a host computer, server other suitable processing device that comprises, for example, one or more processors, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the one or more processors. As will be appreciated, the ARTPMM 160 and SCM 162 may reside on a common programmed computing device or discrete programmed computing devices.

In the charging mode, the ARTPMM 160 is configured to substantially continuously monitor the state of the common DC bus 102 and the charging requirements of the electric vehicle charging stalls 144 via the DC to DC converter modules 150 to determine whether the common DC bus 102 in conjunction with the utility grid 114 and/or solar power source 130 are able to satisfy the charging requirements of the electric vehicle charging stalls 144. The ARTPMM 160 is also configured to protect the BESS 120 by enforcing its permitted upper and lower states of charge and its maximum charge and discharge rates and substantially continuously monitors the state of the BESS 120.

During operation in the charging mode, if the common DC bus 102 in conjunction with the utility grid 114 and/or solar power source 130 are unable to satisfy the charging requirements of the electric vehicle charging stalls 144 and the BESS 120 has a state of charge above its permitted lower charge limit, the ARTPMM 160 signals the bi-directional DC to DC converter 122 and the BESS 120 causing the BESS to discharge DC power to the common DC bus 102 to make up for the charging power deficit. The BESS 120 is allowed to discharge DC power to the common DC bus 102 until the charge level of the BESS 120 reaches its permitted lower charge limit or until the power on the common DC bus 102 is sufficient to satisfy the charging requirements of the electric vehicle charging stalls 144. If the common DC bus 102 still requires additional DC power to satisfy the charging requirements of the electric vehicle charging stalls 144 or if the BESS 120 has a state of charge at or below its permitted lower charge limit, the ARTPMM 160 signals the DC to DC converter modules 150 to reduce/curtail the DC power available to the electric vehicle charging stalls 144. During DC power discharge, the ARTPMM 160 monitors the discharge rate of the BESS 120 to ensure the discharge rate of the BESS 120 does not exceed its maximum discharge rate.

If the charge limit of the BESS 120 is below its permitted upper state of charge and available DC power is on the common DC bus 102, the ARTPMM 160 signals the bi-directional DC to DC converter 122 and the BESS 120 allowing the BESS to draw DC power from the common DC bus 102 until the state of charge of the BESS 120 reaches its permitted upper charge limit or until excess DC power is no longer available on the common DC bus 102. During charging, the ARTPMM 160 monitors the charge rate of the BESS 120 to ensure the charge rate of the BESS 120 does not exceed its maximum charge rate.

In the recovery mode, the ARTPMM 160 is configured to allow power aggregated on the common DC bus 102 to be exported to the utility grid 114. In this embodiment, the energy aggregation system 100 is conditioned to the recovery mode when the ARTPMM 160 receives a generation setpoint from an upstream utility grid operator. The generation setpoint determines the amount of power that is to be delivered from the common DC bus 102 to the utility grid 114.

During operation in the recovery mode when it is desired to provide DC power from the common DC bus 102 back to the utility grid 114, DC power delivered to the common DC bus 102 by the solar power source 130 and DC to DC converter 132 and DC power delivered to the common DC bus 102 by electric vehicle loads connected to the electric vehicle charging stalls 144 are used as the primary sources of power to the common DC bus 102. The BESS 120 in the recovery mode either charges by drawing excess DC power from the common DC bus 102 if the state of charge of the BESS 120 is below its upper charge limit or discharges DC power to the common DC bus 102 if the state of charge of the BESS 120 is below its lower charge limit to balance DC power on the common DC bus 102 in real-time.

In particular, the power on the common DC bus 102 is balanced according to the equation:

P_ESS=P_2grid_ref−P_renewable−ΣP_EV_Loads

where:
P_ESS is the DC power drawn from or discharged to the common DC power bus 102 (+ve during discharge and −ve during charging);
P_2grid_ref is the generation setpoint received from the utility grid operator;
P_renewable is the DC power delivered to the common DC bus 102 by the solar power source 130; and
ΣP_EV_Loads is the total power delivered to the common DC bus 102 by electric vehicle loads connected to the electric vehicle charging stalls 144.

As will be appreciated by those of skill in the art, at times when the generation setpoint P_2grid_ref is zero (0) or small, power can be delivered to the common DC bus 102 from electric vehicle loads and stored by the BESS 120 for later delivery to the common DC bus 102 provided the state of charge of the BESS 120 is below its upper charge limit. This permits the energy aggregation system 100 to satisfy upcoming or future generation setpoints that may be set when expected or anticipated electric vehicle load resources are unavailable.

By using a common DC bus 102 to aggregate DC power for subsequent delivery to the utility grid 114, electrical noise delivered to the utility grid 114 can be minimized or avoided. As will be appreciated by those of skill in the art, power conversion devices typically generate unwanted noise especially when their operating powers are lower than their rated powers. If not filtered properly cascaded power from multiple power conversion devices can result in unwanted harmonics being injected into the utility grid 114 and exacerbating the Total Harmonic Distortion (THD) of the utility grid. In the above embodiment, by aggregating the DC power from all DC power sources onto the common DC bus 102, the feeder station 116 is able to filter and stabilize AC power delivered to the utility grid 114 so that only “clean” AC power is delivered to the utility grid 114.

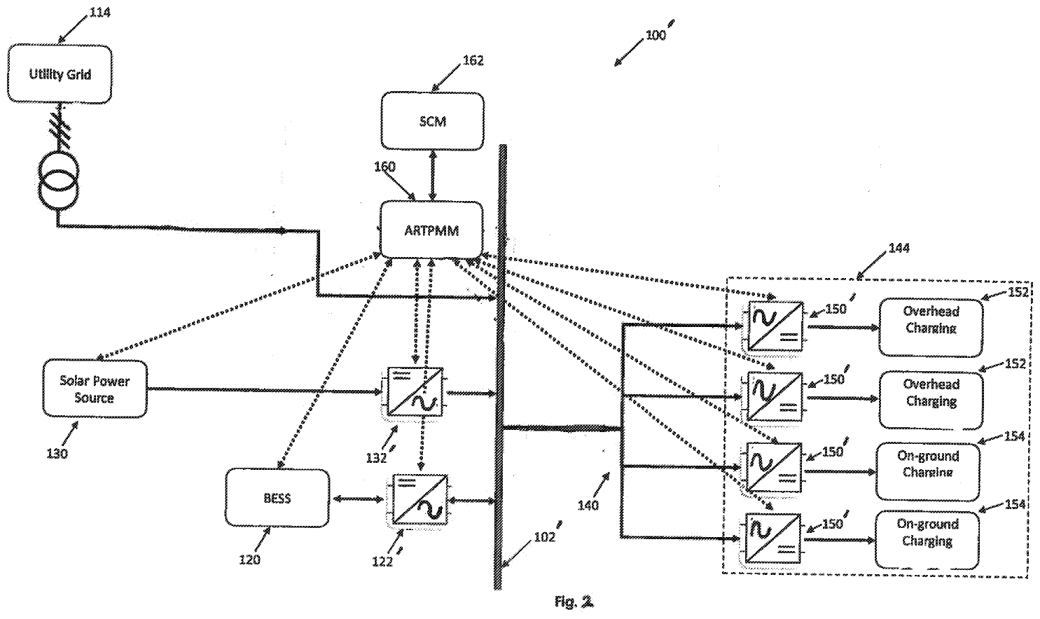

Although the energy aggregation system 100 has been described as comprising a common DC bus 102 on which DC power is aggregated, those of skill in the art will appreciate that alternatives are available. For example, turning now to FIG. 2 an alternative energy aggregation system is shown and is generally identified by reference numeral 100′. In this embodiment, common components in the energy aggregation systems 100 and 100′ will be identified using the same reference character. The energy aggregation system 100′ is very similar to the previous embodiment but in this case comprises a common AC bus 102′ on which power is aggregated rather than a common DC bus as in the previous embodiment. The common AC bus 102′ is connected to the utility grid 114 via circuit breakers and contactors, a static VAR compensator, and a transformer. As the common AC bus 102′ aggregates AC power, no feeder station power conditioning circuity to convert DC power to AC power or to convert AC power to DC power is required. The solar power source 130 is connected to the common AC bus 102′ via an inverter 132′ rather than a DC to DC converter as in the previous embodiment. The inverter 132′ converts the DC power output of the solar power source 130 to AC power for delivery to the common AC bus 102′. The BESS 120 is connected to the common AC bus 102′ via bidirectional power conditioning circuitry comprising a DC to AC converter rather than a DC to DC converter as in the previous embodiment. Each electric vehicle charging stall 144 comprises a bidirectional AC to DC converter module 150′ interconnecting the electric vehicle charging interface 152, 154 and the common AC bus 102′. Each AC to DC converter module 150′ comprises a high frequency step down transformer, and an AC to DC converter that are connected in series.

The operation of the energy aggregation system 100′ is very similar to that of the previous embodiment except that AC power is aggregated on the common AC bus 102′ rather than DC power. In this embodiment, the power ramp rate and control cyclic frequency of the bidirectional DC to AC converter interconnecting the BESS 120 and the common AC bus 102′ is at least twice those of other DC to AC converters within the energy aggregation system 100′ such as those within the AC to DC converter modules 150′ of the electric vehicle charging stalls 144. In some embodiments, the power ramp rate and control cyclic frequency of the bidirectional DC to AC converter interconnecting the BESS 120 and the common AC bus 102′ are at least ten (10) times those of other AC to DC converters within the energy aggregation system 100′ As will be appreciated, controlling the power ramp rate and control cyclic frequency in this manner avoids power interruptions/inconsistencies associated with electric vehicle loads coupled to the electric vehicle charging stalls 144.

Although embodiments have been described, those of skill in the art will appreciate that variations and modifications may be made without departing from the scope of the appended claims.

What is claimed is:

1 An energy aggregation system comprising:
a bus configured to receive power from one or more power sources and to deliver power to a grid connected to the bus;
at least one energy storage system connected to the bus and configured either to draw power from the bus or discharge power to the bus;
at least one electric vehicle charging stall connected to the bus and configured to deliver power, from an electric vehicle load connected to the at least one electric vehicle charging stall, to the bus; and
at least one control module configured to monitor power on the bus and control delivery of power from the bus to the grid.

2. The energy aggregation system of claim 1, comprising a plurality of electric vehicle charging stalls, each electric vehicle charging stall configured to deliver power, from an electric vehicle load connected to the electric vehicle charging stall, to the bus.

3. The energy aggregation system of claim 2, comprising at least one renewable energy source configured to deliver power to the bus.

4. The energy aggregation system of claim 3, wherein the at least one renewable energy source comprises at least one solar power and/or wind power source.

5. The energy aggregation system of claim 3, wherein the at least one control module is configured to control delivery of power from the bus to the grid according to a setpoint.

6. The energy aggregation system of claim 5, wherein the setpoint is determined by an operator of the grid.

7. The energy aggregation system of claim 5, wherein the at least one control module is configured to condition operation of the at least one energy storage system either to draw power from the bus or discharge power to the bus in order to balance power on the bus.

8. The energy aggregation system of claim 7, wherein the at least one control module is configured to (i) condition the at least one energy storage system to draw power from the bus when excess power is on the bus and the state of charge of the at least one energy storage system is below an upper state of charge level, and (ii) condition the at least one energy storage system to discharge power to the bus when insufficient power is on the bus and the state of charge of the at least one energy storage system is above a lower state of charge level.

9. The energy aggregation system of claim 8, wherein power on the bus is balanced according to the equation:
P_ESS=P_2grid_ref−P_renewable−ΣP_EV_Loads
where:
P_ESS is the power drawn from or discharged to the bus by the at least one energy storage system;
P_2grid_ref is the setpoint;
P_renewable is the power delivered to the bus by the at least one renewable power source; and
ΣP_EV_Loads is the total power delivered to the bus by electric vehicle loads connected to the electric vehicle charging stalls.

10. The energy aggregation system of claim 3, wherein the bus is a direct current (DC) bus, and wherein the at least one renewable energy source, the at least one energy storage system and the electric vehicle charging stalls deliver DC power to the DC bus.

11. The energy aggregation system of claim 10, wherein at least one of each renewable energy source, and each energy storage system is connected to the DC bus via a DC to DC converter.

12. The energy aggregation system of claim 11, wherein each renewable energy source, and each energy storage system is connected to the DC bus via a DC to DC converter.

13. The energy aggregation system of claim 10, wherein each electric vehicle charging stall comprises a DC to DC converter module and an electric vehicle charging interface.

14. The energy aggregation system of claim 13, wherein each DC to DC converter module comprises a DC to AC converter, a high frequency step down transformer, and an AC to DC converter connected in series.

15. The energy aggregation system of claim 10, wherein the grid is an alternating current (AC), three phase utility grid and the energy aggregation system further comprises power conditioning circuitry to filter and convert DC power on the bus to AC power for delivery to the grid.

16. The energy aggregation system of claim 3, wherein the bus is an alternating current (AC) bus, and wherein the at least one renewable energy source, the at least one energy storage system and the electric vehicle charging stalls deliver AC power to the AC bus.

17. The energy aggregation system of claim 16, wherein each renewable energy source, and each energy storage system is connected to the AC bus via a DC to AC converter.

18. The energy aggregation system of claim 16, wherein each electric vehicle charging stall comprises a DC to AC converter module and an electric vehicle charging interface.

19. The energy aggregation system of claim 1, wherein the at least one energy storage system is at least one battery energy storage system comprising a plurality of rechargeable batteries.
